(19) United States
(12) Patent Application Publication
(10) Pub. No.: US 2005/0150101 A1
(43) Pub. Date: Jul. 14, 2005

(54) Apparatus and method for holding an object

(76) Inventor: Paul Langer, Vernon Hills, IL (US)

Correspondence Address: Fullin Legal Services LLC, 711 N. Milwaukee Avenue, Libertyville, IL, 60048, US

(21) Appl. No.: 10/757,621

(22) Filed: Jan. 14, 2004

(51) Int. Cl. B23Q 7/00

(52) U.S. Cl. 29/559

(57) ABSTRACT

An apparatus and method for holding an object by a one-piece clip includes the use of a base (101) having an opening (107) and a top member (113) having a grasping end (115) that extends into the opening (107) are described. The clip includes a bendable fulcrum (111) that elastically connects the base (101) to the top member (113). Tension produced by a bent bendable fulcrum (111) is utilized to hold the object between a base grasping end (103) and the top member grasping end (115). The one-piece clip can be manufactured by injection molding of a thermoplastic.

### B. CROSS-REFERENCE TO RELATED APPLICATIONS

Not Applicable

### STATEMENT REGARDING FEDERALLY SPONSORED RESEARCH/DEVELOPMENT

The present invention does not involve any form of federally sponsored research or development.

### BACKGROUND OF THE INVENTION

Devices and methods for holding objects, particularly by a clip, are known. Clips come in a variety of designs depending on the type and thickness of the object or objects being held. Many clips are designed for use with papers. Other clips have been designed to hold x-rays, fabric, cloth, pictures, posters, decorations, and so forth. Complex clips designs have special surfaces to distribute the grasping forces and protect the held object from damage. In general, clips are formed by two elastic members that contact or are proximately close to each other. The members are often co-planar, or approximately parallel to each other. Clips are formed from multiple components or from a complex arrangement of a single component. For example, metals clips can be formed by assembling two metal pieces or by bending a metal wire to form adjacent members. Plastic clips can be formed by the co-extrusion of a soft and hard synthetic resin or by special molding that creates internal stress to bias members towards each other.

The clip business is competitive, and clips designs that minimize raw materials and manufacturing complexity are desirable. A single piece clip can be inexpensively manufactured by injection molding of a thermoplastic provided the elastic members are formed to produce a desirable holding tension without being in contact with each other.

Accordingly, there is a need for an apparatus for and method of holding an object, which apparatus includes a base having an opening and a top member having a grasping end that extends through the opening, and which method holds an object by grasping it between the grasping end of the top member and a base grasping end having the opening.

### BRIEF SUMMARY OF THE INVENTION

An apparatus and a method for grasping and holding an object are provided. The apparatus includes a base having an opening, a bendable fulcrum, and a top member having a grasping end that extends through the opening. The steps of the method include squeezing a handle end of the apparatus to separate grasping end members, inserting an object between the grasping end members, and releasing the handle end to allow tension in the apparatus to grab the object with the grasping end members.

### BRIEF DESCRIPTION OF THE DRAWINGS

FIG. 1A illustrates a top view of an apparatus having a base with an opening and a top member that extends into and through the opening.

FIG. 1B illustrates a bottom view of an apparatus having a base with an opening and a top member that extends into and through the opening.

FIG. 2 illustrates an embodiment of an apparatus that has a gripping member that extends below the plane of a base bottom.

FIG. 3 is a flowchart illustrating a method for use in holding an object with a clip.

### DETAILED DESCRIPTION OF THE PREFERRED EMBODIMENT

The present invention includes an apparatus and method for holding an object, such as a clip. Clips are made of materials that have tensile strength such as metal or plastic, and typically include two members that are elastically connected. The two members are separated such that an inherent elasticity creates a tension for holding objects in place between the two members. The grasping members include a base having an opening and a top member that extends into the opening. A bendable fulcrum elastically connects the two members. Squeezing a handle end of the clip separates the grasping ends of the two members, and a tension from the inherent elasticity in the bendable fulcrum can hold an object when the handle end of the clip is released.

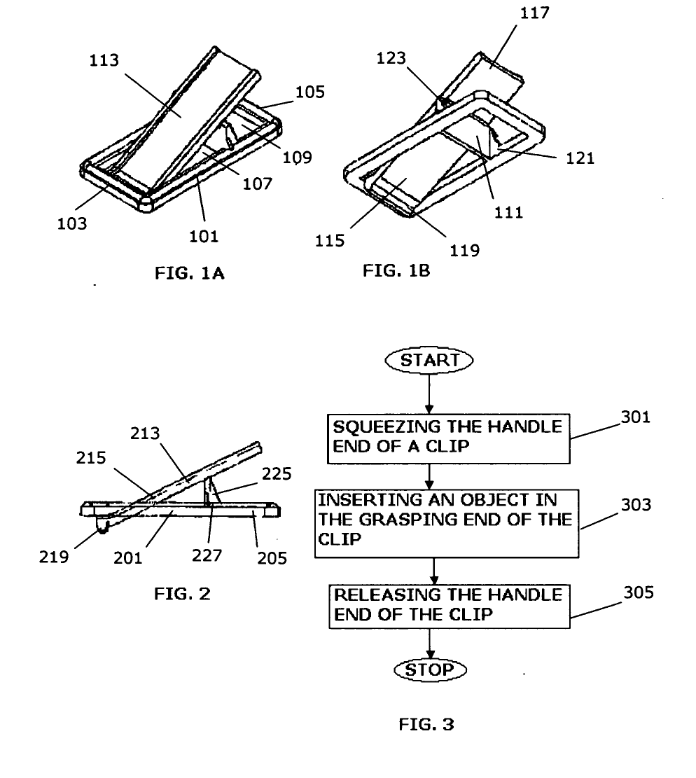

A clip that comprises a base 101 that includes a grasping end 103, and a handle end 105 is shown in FIG. 1A. The base 101 has an opening 107 in the grasping end 103. As shown in FIG. 1A, the base 101 is planar and consists of four side members that form a rectangular base 101 and a rectangular opening 107. In the embodiment, a second rectangular opening 109 is also formed in the handle end 105 of the base. Alternatively, the base and openings can be other geometric shapes such as circles, triangles, ellipses, non-regular shapes, and so forth. In addition, the base can be formed with a single opening 107 such that the handle end 105 is solid and without an opening.

A top member 113 is elastically connected the base 101 by a bendable fulcrum 111. A grasping end 115 of the top member extends into the opening 107 and can extend to or below a plane formed by the bottom of the base 101.

As shown in FIG. 2B, a gripping member 119 for holding the object can be formed at a tip of the grasping end 115. Supports 121 and 123 can be attached between the base 105 and the bendable fulcrum 111. The supports stiffen the attachment of the fulcrum to the base and limit the bending of the fulcrum to a portion near the attachment to the top member 113. The fulcrum 111 can have a fillet where the fulcrum is attached to the top member 113 for added strength.

The holding of an object by the apparatus is initiated by squeezing the handle end of the clip. The handle end of the clip includes the top member handle end 117 that is squeezed towards the base handle end 105. The top member 113 rotates on the bendable fulcrum 111 which causes the top member grasping end 115 to separate from the base grasping end 103. As the grasping ends separate, tension results from the inherent elasticity in the bendable fulcrum 111, the base 101, and the top member 113. An object is inserted between the separated grasping ends, 103 and 115, and the handle ends, 105 and 117, are released. The object is grasped by the grasping ends, 103 and 115, and held by tension from the inherent elasticity that remains from the clip in a partially bent position.

An embodiment shown in FIG. 2 depicts a side view of a single piece clip. A base 201 has a grasping end with a single opening (not shown) and a solid handle end 205 without an opening. Alternatively, the handle end 205 can be designed to facilitate surface mounting the clip by the incorporation of a hole for a nail or screw, an adhesive backing, and so forth. The top member 213 is supported on a bendable fulcrum 225. The bendable fulcrum 225 has pyramidal shape that is wider at a fulcrum bottom 227. The pyramidal shape stiffens and strengthens supports for the bendable fulcrum. The width of the pyramidal shape may extend across the width of the top member 213, and the height of the pyramidal shape may be increased or decreased to accommodate the holding of different size objects.

The grasping end 215 of the top member 213 extends below a plane formed by the bottom of the base 201. A gripping tip 219 that is formed to grab the object is attached to the top member grasping end 215. The gripping tip 219 can incorporate grooves or other formations and structures to facilitate the holding of the object by the clip.

A flowchart that illustrates a method for use with holding an object with a clip is shown in FIG. 3. At step 301, the handle ends of the base and top member, 105 and 117, are squeezed towards each other. The squeezing causes the top member 113 to rotate around the bendable. fulcrum 111 such that the grasping ends of the base and the top member, 103 and 115, move away from respective starting positions and become separated. At step 303, an object is placed in between the separated grasping ends, 103 and 115. Transversing the base opening 107 by the object is a desirable position for the object. Alternatively, the object need not transverse the opening 107; however, there may be some loss in holding effectiveness.

At step 305, the handle ends of the base and top member, 105 and 117, are released. The inherent elasticity of the bendable fulcrum 111, the base 101, and the top member 113 causes the grasping ends, 103 and 115, to move towards respective starting positions. As the grasping ends, 103 and 115, move, the object is contacted, grasped, and held by the grasping ends.

An advantage of the present invention is the formation of a single-piece clip that can be manufactured by injection molding of a single thermoplastic. A single-piece clip is less complicated to manufacture than clips that require assembly of two or more clip components. A clip made of one material eliminates complex molding of multiple materials and the need for additional raw material inventory. The clip is formed from non-contacting and non-coplanar members and can be easily manufacture by injection molding, and there is no need to form the clip with inherent tension. The clip design is also amiable to modification to facilitate the holding of different types or number of objects. For example, the height of the bendable fulcrum may be adjusted to accommodate different size objects. Finally, the design uses inexpensive plastics as compared to metal.

The present invention can be embodied in other specific forms without departing from its spirit or essential characteristics. The described embodiments are to be considered in all respects only as illustrative and not restrictive. All changes that come within the meaning and range of equivalency of the claims are to be embraced within their scope.

1. An apparatus comprising:
a base having a handle end and a grasping end wherein the base grasping end has an opening;
a bendable fulcrum attached to the base proximately close to the opening; and
a top member attached to the bendable fulcrum and having a handle end and a grasping end wherein the top member grasping end extends into the opening;

2. The apparatus of claim 1, wherein the base, the bendable fulcrum, and the top member form a single piece.

3. The apparatus of claim 2, wherein the single piece is formed by the injection molding of a thermoplastic.

4. The apparatus of claim 1, wherein the base is a planar shape, the bendable fulcrum is a planar shape, and the fulcrum member intersects the base at a ninety degree angle.

5. The apparatus of claim 1, wherein the top member grasping end extends through the opening.

6. The apparatus of claim 1, further comprising at least one support attached to the base and the fulcrum member.

7. The apparatus of claim 1, further comprising a gripping member attached to the top member grasping end.

8. The apparatus of claim 7, wherein the gripping member contains grooves.

9. The apparatus of claim 1 further comprising at least one fillet where the top member is attached to the fulcrum.

10. A method comprising the steps of:
squeezing a top member handle end towards a base handle end wherein a top member grasping end and a base grasping end separate and tension is created in a bendable fulcrum that connects a base and a top member;
inserting an-object between the base grasping end and the top member grasping end; and
releasing the top member handle end and the base handle end wherein tension causes the base grasping end and the top member grasping end to grab the object.

11. A method of claim 9, further comprising the step of attaching the base to a surface.
